(19) United States
(12) Patent Application Publication
(10) Pub. No.: US 2014/0169317 A1
(43) Pub. Date: Jun. 19, 2014

(54) METHOD AND APPARATUS FOR SWITCHING ANTENNA PORT CONFIGURATIONS

(71) Applicants: Chunyan Gao, Beijing (CN); Wei Bai, Beijing (CN); Juho Mikko Oskari Pirskanen, Tampere (FI); Erlin Zeng, Beijing (CN); Haiming Wang, Beijing (CN); Jing Han, Beijing (CN)

(72) Inventors: Chunyan Gao, Beijing (CN); Wei Bai, Beijing (CN); Juho Mikko Oskari Pirskanen, Tampere (FI); Erlin Zeng, Beijing (CN); Haiming Wang, Beijing (CN); Jing Han, Beijing (CN)

(73) Assignee: Broadcom Corporation, Irvine, CA (US)

(21) Appl. No.: 14/234,790

(22) PCT Filed: Jul. 25, 2011
(86) PCT No.: PCT/CN2011/077548

§ 371 Date: Jan. 24, 2014

(51) Int. Cl. H04B 7/04; H04W 72/04

(52) U.S. Cl. CPC H04B 7/0404; H04W 72/042
USPC 370/329

(57) ABSTRACT

A method and apparatus are provided to provide for timely switching between antenna port configurations as the mode of operation of a mobile terminal changes which may, in turn, dictate different combinations of the MIMO, CoMP and/or CA capabilities. In this regard, a method is provided that includes utilizing one or more antennas in a first antenna port configuration in a first mode of operation. The method may also receive a command that triggers switching to another antenna port configuration and then determines another one of a plurality of antenna port configurations to be utilized in response to the command. The method may then utilize one or more antennas of the another one of the antenna port configurations in a second mode of operation. A corresponding apparatus and computer program product are also provided.

### TECHNOLOGICAL FIELD

Embodiments of the present invention relate generally to communications technology and, more particularly, to methods and apparatus for switching antenna port configurations as the mode of operation of a mobile terminal changes.

### BACKGROUND

There is increasing emphasis for wireless communication systems to provide higher data rates so as to allow for increased throughput. In this regard, Long-Term Evolution (LTE) and LTE-Advanced systems have been developed so as to provide enhanced services including higher data rates and reduced latency at lower cost. In order to support higher data rates and the resulting improvements in throughput, Release 10 of the LTE specification has adopted both carrier aggregation (CA) and downlink (DL)/uplink (UL) multiple input and multiple output (MIMO) capabilities. CA capability and DL/UL MIMO capability are defined separately for mobile terminals that operate in accordance with the LTE specification and, as such, the CA and DL/UL MIMO capabilities may be configured independently.

In order to enable DL/UL MIMO capability, a mobile terminal must implement multiple radio frequency (RF) filters and antennas. While a mobile terminal may utilize a single RF filter and antenna to provide for UL CA in a single band, a mobile terminal may also require multiple RF filters and antennas in order to support inter-band DL/UL CA in which carriers from different bands are aggregated. In this regard, a mobile terminal may require multiple RF filters and antennas to support inter-band DL/UL CA due to filter bandwidth limitations and/or possible timing advance differences in the carriers.

As such, a mobile terminal that is required to concurrently support both DL/UL MIMO and inter-band CA may require even more RF filters and antennas. This increase in RF filters and antennas not only increases the complexity of a mobile terminal, but may also increase the cost of the mobile terminal. Additionally, it has been proposed that a mobile terminal shall support the number of MIMO layers according to its category on all supported band combinations. As the number of DL/UL MIMO layers that are supported increases, the number of RF filters and antennas that are required will also increase, perhaps to a point at which it is no longer practical to assume that a mobile terminal may support the maximum combination of DL/UL MIMO layers and inter-band CA simultaneously.

MIMO is generally most effective for mobile terminals that are operating in a channel having a good signal to noise ratio (SNR) with a limited number of different multi-path components and are moving at a relatively low speed, thereby ensuring that the correlation between different MIMO antennas is relatively small. In order for a mobile terminal to satisfy these conditions, the mobile terminal must generally be within the center of a cell and not along the border of the cell.

By utilizing CA, a mobile terminal may enjoy increased bandwidth that is available independent of the channel type or location of the mobile terminal. In an instance in which the channel bandwidth is increased beyond a certain point, however, the relative gains provided by the frequency selective scheduling may become smaller due to the potential lack of a sufficient number of good frequency bands. However, the increased bandwidth is still available and may be utilized, for example, by an access point, such as an evolved Node B (eNB), so as to increase the DL bit rate. However, if the number of mobile terminals in a serving cell is relatively large, not all mobile terminals can be configured for CA and the access point must select a suitable set of mobile terminals to be configured for CA. In this regard, in order to increase the system throughput, the access point may configure the maximum number of MIMO layers to the mobile terminals that have relatively high SNR values and utilize the extended transmission bandwidth attributable to CA for those mobile terminals that have a lower SNR, but still have a relatively high throughput requirement. Depending upon the channel characteristics, such as the speed at which the mobile terminal is moving, the environment, etc., however, the most suitable system configuration in regards to CA capability and/or DL/UL MIMO capability may repeatedly change.

Thus, a mobile terminal may be configured to switch between MIMO and CA capabilities based on link status and load status within the serving cell so as to provide an improved data rate. Additionally, by switching between MIMO and CA capabilities, the number of RF filters and antennas that are required may be reduced relative to mobile terminals configured to have MIMO and CA capabilities simultaneously. In this regard, switching between the MIMO and CA capabilities may allow the same RF filters and antennas to be shared between and to support both MIMO and CA capabilities in an alternate or a timed division multiplexed manner.

In an analogous manner to that in which switching between MIMO and CA capabilities may be beneficial for a mobile terminal, switching between coordinated multipoint transmission (CoMP) capability and CA capability may also be beneficial in terms of providing improved performance while avoiding requirements for additional RF filters and antennas. For example, an LTE system may include an access point, such as an eNB, and a radio remote head (RRH) that each support carrier i and carrier j. At one instance, a mobile terminal may be configured for CA of carriers i and j with carrier i being transmitted from the access point and carrier j being transmitted from the RRH. Following a change in the channel characteristics, however, the access point may configure the mobile terminal to use CoMP for carrier i with both the access point and the RRH transmitting on carrier i.

As noted above, switching between CA and MIMO capabilities based on link and load status within a serving cell may support improved data rates for the mobile terminal while moderating the number of RF filters and antennas that may be required. In accordance with the 3GPP specification for LTE-A, this switching between MIMO and CA capabilities may be realized via radio resource control (RRC) signaling, e.g., carrier reconfiguration signaling and transmission mode configuration signaling. Unfortunately, RRC signaling provides for a relatively slow switching process. This relatively slow switching process may delay switching for up to a few hundreds of milliseconds, thereby limiting the rate at which an access point may switch between modes since the access point cannot send frequent RRC signaling messages. Additionally, due to the signaling delay introduced by the RRC signaling messages, the access point may not be able to adapt to changes in the channel characteristics of the mobile terminals in an efficient and timely manner. As such, the system configuration may at least sometimes be sub-optimum since by the time that a switch between the CA and MIMO capabilities may have been affected, the channel characteristics may have further changed such that the current CA and MIMO capabilities are no longer the most appropriate.

The signaling delay relating to changes in the CA and MIMO capabilities may also be an obstacle to efficient utilization of the RF capabilities. For example, a mobile terminal configured with inter-band CA may not have the aggregated carriers activated and scheduled in the same subframe. In this instance, the mobile terminal may essentially rely upon the single carrier transmission with the RF filter and antenna in the other band not being utilized. Or, in an instance in which a mobile terminal has multiple MIMO layers configured, but the channel characteristics only allow a single layer transmission, an RF filter and antenna may be unused even though another carrier suitable for CA operation would have spare capacity. Such under-utilization of the RF capability of the mobile terminal may be evidenced through lower system throughput than that which the mobile terminal could otherwise support.

### BRIEF SUMMARY

A method and apparatus are therefore provided according to an example embodiment in order to provide for improved switching between antenna port configurations as the mode of operation of a mobile terminal changes. In this regard, the method and apparatus of one embodiment may facilitate switching between antenna port configurations in order to support different combinations of the MIMO, CoMP and/or CA capabilities of a mobile terminal. By providing for switching between antenna port configurations in an efficient and timely manner, the antenna port configuration of a mobile terminal may more closely track the channel characteristics such that the resulting system performance is improved. Thus, the method and apparatus of one embodiment may facilitate more efficient utilization of the RF capability of a mobile terminal while providing for improvements in the data rate and overall performance of a mobile terminal.

In one embodiment, a method is provided that includes utilizing one or more antennas in a first antenna port configuration in a first mode of operation. The method of this embodiment also receives a command that triggers switching to another antenna port configuration and then determines another one of a plurality of antenna port configurations to be utilized in response to the command. The method may then utilize one or more antennas of the another one of the antenna port configurations in a second mode of operation.

In another embodiment, an apparatus is provided that includes at least one processor and at least one memory including computer program code with the at least one memory and the computer program code configured to, with the at least one processor, cause the apparatus at least to utilize one or more antennas in a first antenna port configuration in a first mode of operation and to receive a command that triggers switching to another antenna port configuration. The at least one memory and the computer program code are also configured in one embodiment to, with the at least one processor, cause the apparatus to determine another one of a plurality of antenna port configurations to be utilized in response to the command and to then utilize one or more antennas of the another one of the antenna port configurations in a second mode of operation.

In a further embodiment, a computer program product is provided that includes at least one non-transitory computer-readable storage medium having computer-readable program instructions stored therein with the computer-readable program instructions including program instructions configured to utilize one or more antennas in a first antenna port configuration in a first mode of operation and program instructions configured to receive a command that triggers switching to another antenna port configuration. The computer-readable program instructions of this embodiment may also include program instructions configured to determine another one of a plurality of antenna port configurations to be utilized in response to the command and program instructions configured to utilize one or more antennas of the another one of the antenna port configurations in a second mode of operation.

In yet another embodiment, an apparatus is provided that includes means for utilizing one or more antennas in a first antenna port configuration in a first mode of operation. The apparatus of this embodiment also includes means for receiving a command that triggers switching to another antenna port configuration and means for determining another one of a plurality of antenna port configurations to be utilized in response to the command. The apparatus may also include means for utilizing one or more antennas of the another one of the antenna port configurations in a second mode of operation.

In one embodiment, a method is provided that includes providing for communications with a mobile terminal in a first mode of operation via one or more antennas in a first antenna port configuration. The method of this embodiment may also include causing a command to be sent to the mobile terminal that triggers switching to another antenna port configuration as selected from a plurality of predefined antenna port configurations. Additionally, the method may include providing for communications with the mobile terminal in a second mode of operation via one or more antennas of the another one of the antenna port configurations.

In another embodiment, an apparatus is provided that includes at least one processor and at least one memory including computer program code with the at least one memory and the computer program code configured to, with the at least one processor, cause the apparatus at least to provide for communications with a mobile terminal in a first mode of operation via one or more antennas in a first antenna port configuration. The at least one memory and the computer program code of one embodiment are also configured to, with the at least one processor, cause the apparatus to cause a command to be sent to the mobile terminal that triggers switching to another antenna port configuration as selected from a plurality of predefined antenna port configurations. Additionally, the at least one memory and the computer program code may be configured to, with the at least one processor, cause the apparatus to provide for communications with the mobile terminal in a second mode of operation via one or more antennas of the another one of the antenna port configurations.

In a further embodiment, a computer program product is provided that includes at least one non-transitory computer-readable storage medium having computer-readable program instructions stored therein with the computer-readable program instructions including program instructions configured to provide for communications with a mobile terminal in a first mode of operation via one or more antennas in a first antenna port configuration. The computer-readable program instructions of this embodiment may also include program instructions configured to cause a command to be sent to the mobile terminal that triggers switching to another antenna port configuration as selected from a plurality of predefined antenna port configurations and program instructions configured to provide for communications with the mobile terminal in a second mode of operation via one or more antennas of the another one of the antenna port configurations.

In yet another embodiment, an apparatus is provided that includes means for providing for communications with a mobile terminal in a first mode of operation via one or more antennas in a first antenna port configuration. The apparatus of this embodiment may also include means for causing a command to be sent to the mobile terminal that triggers switching to another antenna port configuration as selected from a plurality of predefined antenna port configurations. Additionally, the apparatus may include means for providing for communications with the mobile terminal in a second mode of operation via one or more antennas of the another one of the antenna port configurations.

### BRIEF DESCRIPTION OF THE SEVERAL VIEWS OF THE DRAWINGS

Having thus described the example embodiments of the invention in general terms, reference will now be made to the accompanying drawings, which are not necessarily drawn to scale, and wherein:

FIG. 1 is a schematic representation of a system in which an example embodiment of the present invention is operable;

FIG. 2 is a block diagram of an apparatus that may be specifically configured to implement an example embodiment of the present invention;

FIG. 3 is a flowchart illustrating the operations performed from the perspective of a mobile terminal in accordance with one embodiment of the present invention;

FIG. 4 is a signaling flow diagram illustrating the messages exchanged between an access point and a mobile terminal in accordance with one embodiment of the present invention;

FIG. 5 is a timing diagram illustrating the exchange of messages between an access point and a mobile terminal on a subframe level in accordance with one embodiment of the present invention;

FIG. 6 is a block diagram of an RF transmitter having a plurality of RF filters and antennas that may be controllably actuated or deactuated in accordance with one embodiment of the present invention; and

FIG. 7 is a flowchart illustrating the operations performed from the perspective of an access point in accordance with one embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are disclosed for providing for improved switching between antenna port configurations as the mode of operation of a mobile terminal changes. As such, the method, apparatus and computer program product of one embodiment may facilitate switching between antenna port configurations in order to support different combinations of the MIMO, CoMP and/or CA capabilities of a mobile terminal. By way of example but not of limitation, a first mode of operation may be MIMO with 4 antenna ports and a single carrier, while a second mode of operation may be MIMO with 2 antenna ports and inter-band CA. In another example, a first mode of operation may be MIMO with 2 antenna ports and intra-band CA, while a second mode of operation may be a single antenna port and inter-band CA. In yet another example, a first mode of operation may be MIMO with 2 antenna ports and a single carrier, while a second mode of operation may be a single antenna port and inter-band CA.

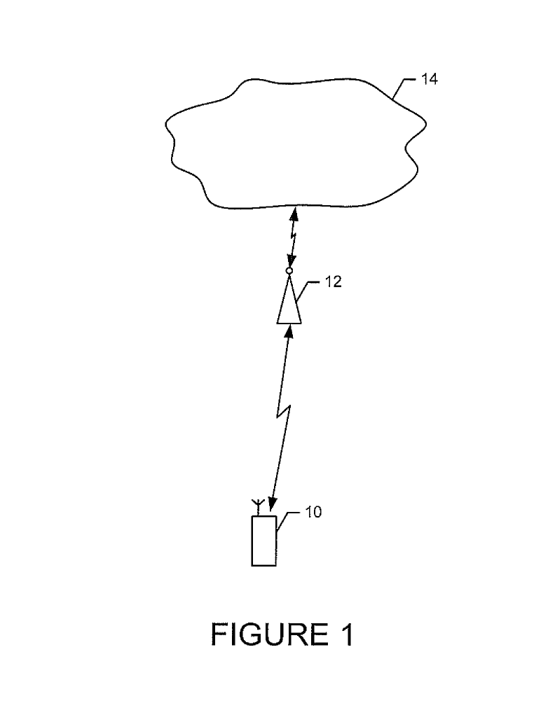

Although the method, apparatus and computer program product may be implemented in a variety of different systems, one example of such a system is shown in FIG. 1, which includes a first communication device (e.g., mobile terminal 10) that is capable of communication via an access point 12, such as a base station, a Node B, an evolved Node B (eNB) or the like, with a network 14 (e.g., a core network). While the network may be configured in accordance with LTE or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more access points 12, each of which may serve a coverage area divided into one or more cells. The access point or other communication node could be, for example, part of one or more cellular or mobile networks or public land mobile networks (PLMNs). In turn, other devices such as processing devices (e.g., personal computers, server computers or the like) may be coupled to the mobile terminal and/or other communication devices via the network.

A communication device, such as the mobile terminal 10 (also known as user equipment (UE)), may be in communication with other communication devices or other devices via the access point 12 and, in turn, the network 14. In some cases, the communication device may include an antenna for transmitting signals to and for receiving signals from an access point, such as via a plurality of component carriers (CCs) including a primary cell (PCell) and one or more secondary cells (SCell) in one mode of operation.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 14.

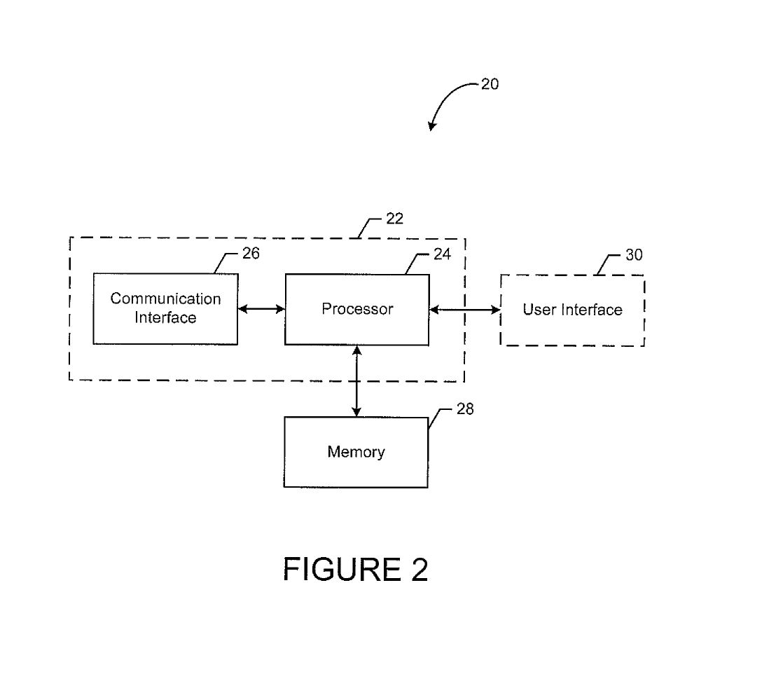

In one embodiment, for example, the mobile terminal 10 and/or the access point 12 may be embodied as or otherwise include an apparatus 20 as generically represented by the block diagram of FIG. 2. While the apparatus may be employed, for example, by a mobile terminal or an access point, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a device interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as an access point 12, the apparatus may not include a user interface. As such, the user interface is shown in dashed lines in FIG. 2.

The device interface 28 may include one or more interface mechanisms for enabling communication with other devices and/or networks. In some cases, the device interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the access point 12. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

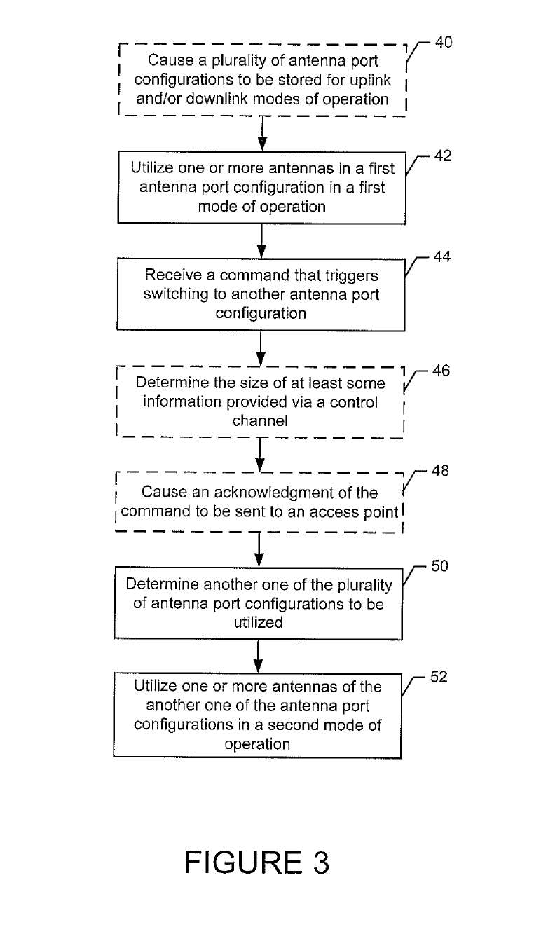

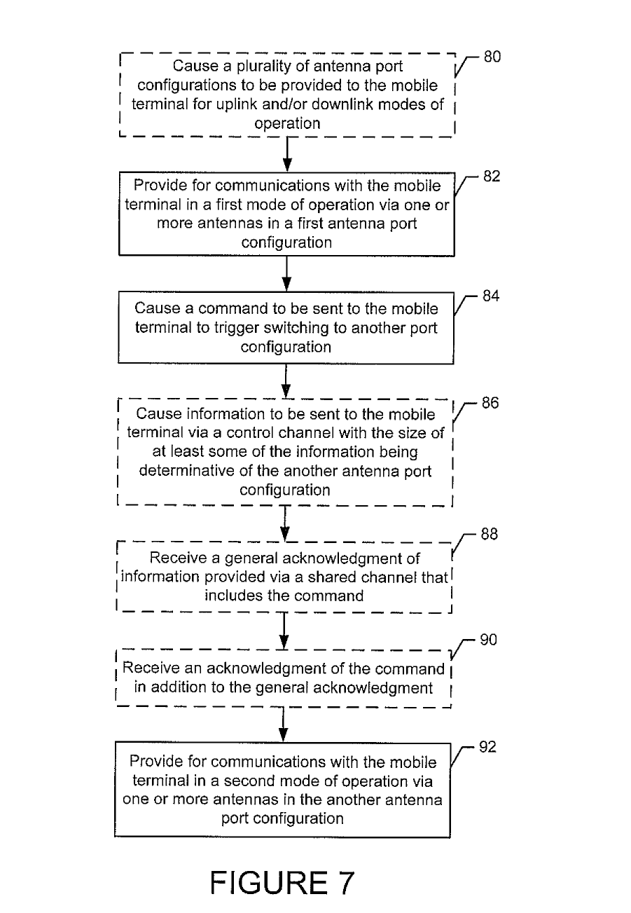

Referring now to FIGS. 3 and 7, flowcharts illustrating the operations performed by a method, apparatus and computer program product, such as apparatus 20 of FIG. 2, from the perspective of a mobile terminal 10 and an access point 12 in accordance with one embodiment of the present invention are illustrated. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 7, when executed, convert a computer or processing circuitry into a particular machine configured to perform an example embodiment of the present invention. Accordingly, the operations of each of FIGS. 3 and 7 define an algorithm for configuring a computer or processing circuitry 22, e.g., processor, to perform an example embodiment. In some cases, a general purpose computer may be provided with an instance of the processor which performs the algorithm of a respective one of FIGS. 3 and 7 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

Although shown in the flowcharts in a somewhat abbreviated manners, certain ones of the operations above may be modified or further amplified as described below. Moreover, in some embodiments additional optional operations may also be included (some examples of which are shown in dashed lines in FIGS. 3 and 9). It should be appreciated that each of the modifications, optional additions or amplifications below may be included with the operations above either alone or in combination with any others among the features described herein.

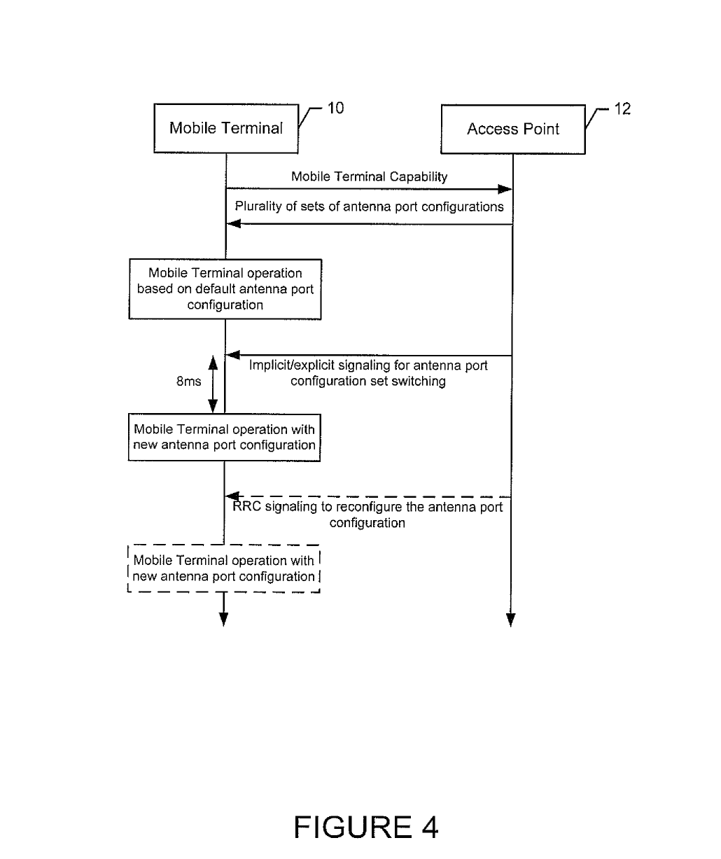

In accordance with one embodiment of the present invention, a mobile terminal 10 is provided that has the capability to switch quickly between different antenna port configurations, thereby allowing the mobile terminal to readily adapt to different modes of operation that take advantage of different capabilities, e.g., MIMO, CoMP and/or CA capabilities, in order to provide high data rates while moderating the number of RF filters and antennas that are required. In accordance with embodiments of the present invention, a plurality of sets of antenna port configurations may be defined. For example, a network 14, such as an access point 12, may define a plurality of different antenna port configurations for a mobile terminal and may provide the sets of antenna port configurations to the mobile terminal. As shown in operation 40 of FIG. 3, for example, the mobile terminal may include means, such as the processing circuitry 22, the processor 24, the memory device 26 or the like, for receiving and for causing the plurality of antenna port configurations to be stored. By way of another example and as shown in FIG. 4, for example, the mobile terminal may advise the access point of its capability for fast switching between different antenna port configurations and the mobile terminal may, in turn, receive and store the plurality of different antenna port configurations between which the mobile terminal can controllably switch as described below.

The plurality of antenna port configurations may include antenna port configurations for UL channels, for DL channels or for both UL and DL channels. In addition, the plurality of antenna port configurations may include different antenna port configurations for the different channels supported by the mobile terminal 10, such as for data, reference signal (RS) and control channels. For example, the antenna port configuration for the sounding reference signals (SRS) channel may consist of a single antenna port, while the antenna port configuration for the physical downlink shared channel (PDSCH) may consist of two antenna ports.

In one example in which the mobile terminal 10 supports 4 Tx/Rx for single band operation and 2 Tx/Rx for two band operation, two sets of antenna port configurations may be defined for the downlink, that is, 2 Rx as a default for a CA mode of operation and 4 Rx for a single carrier mode of operation. Alternatively or additionally, four sets of antenna port configurations may be defined for the uplink, such as set 1 including SRS with 0 antenna ports, physical uplink shared channel (PUSCH) with 2 antenna ports and physical uplink control channel (PUCCH) with 1 antenna port, set 2 including SRS with 1 antenna port, PUSCH with 2 antenna ports and PUCCH with 2 antenna ports, set 3 including SRS with 1 antenna port, PUSCH with 4 antenna ports and PUCCH with 1 antenna port, and set 4 including SRS with 4 antenna ports, PUSCH with 4 antenna ports and PUCCH with 1 antenna port.

The network 14 and/or the access point 12 may identify one of the antenna port configurations as a default configuration to be utilized in the absence of instructions or other indications that a different one of the antenna port configurations is to be utilized. As described below, the other antenna port configurations may be associated with different channels and/or different modes of operation, such as MIMO, CoMP, intraband CA, inter-band CA or the like. As such, the network and/or the access point may also provide the mobile terminal 10 with information regarding the channels and/or modes of operation that are associated with the various antenna port configurations and the mobile terminal may, in turn, store this information in association with the antenna port configurations.

As shown in operation 42 of FIG. 3, the apparatus 20 embodied by the mobile terminal 10 may include means, such as the processing circuitry 22, the processor 24, the device interface 28 or the like, for utilizing one or more antennas of a first antenna port configuration in a first mode of operation, such as the transmission of data via an UL, the reception of data via a DL or another mode of operation. The first antenna port configuration may be the default configuration as shown in FIG. 4 or may be an antenna port configuration that is defined for the first mode of operation in which the mobile terminal is currently operating.

The apparatus 20 embodied by the mobile terminal 10 may also include means, such as the processing circuitry 22, the processor 24, the device interface 28 or the like, for receiving a command, either implicitly or explicitly, from the access point 12 that triggers switching to another antenna port configuration, such as in response to change in the mode of operation of the mobile terminal, a change in the channel utilized by the mobile terminal, or the like. See operation 44 of FIG. 3 as well as in FIG. 4. In one embodiment, the different modes of operation of the mobile terminal may include a MIMO mode of operation, a CoMP mode of operation, an intra-band CA mode of operation or an inter-band CA mode of operation. By way of example, the command to trigger switching to another antenna port configuration may occur in conjunction with a transition from a MIMO mode of operation to a CA mode of operation, or vice versa. However, other modes of operation may be defined including various combinations of the aforementioned modes. By particularly configuring different antenna port configurations for these different modes of operation, the number of RF filters and antennas that are required to support the modes of operation may be moderated while still providing for relatively high data rates and low latency.

In one embodiment in which the command implicitly triggers switching to another antenna port configuration, the mobile terminal 10, such as the processor 24, may receive a command, such as an activation command or deactivation command for a respective carrier band, that implicitly directs the mobile terminal to switch to another antenna port configuration in order to better support the carrier band that will be utilized following execution of the command. By way of example, the mobile terminal, such as the processor, may receive an activation command from the access point 12 for a respective carrier band. This activation command may be indicative of a transition from a first mode of operation to a second mode of operation. As another example, the mobile terminal, such as the processor, may receive a deactivation command for a carrier band that is similarly indicative of a transition from a first mode of operation to a second mode of operation.

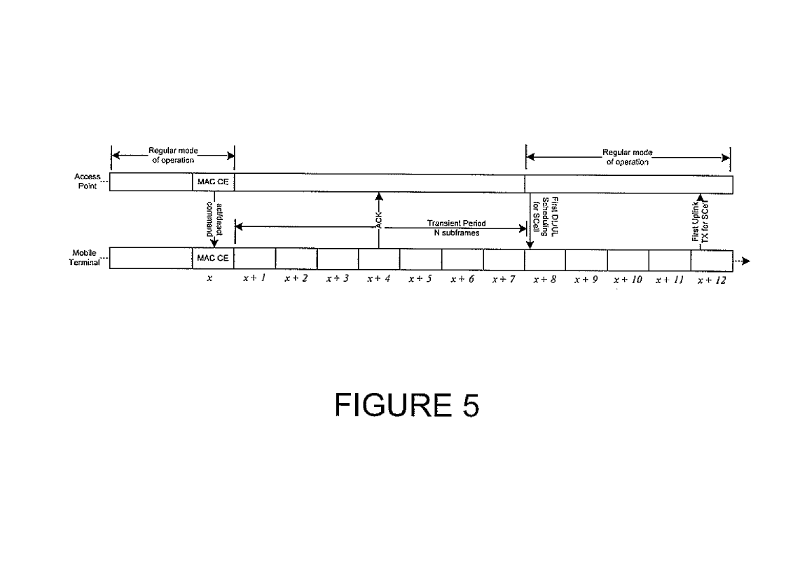

As shown in more detail in FIG. 5, an activation command may be issued by the access point 12 at subframe x with the activation command intended to provide for secondary cell (SCell) activation in a CA mode of operation. The activation command may be provided in various manners, but, in this embodiment, is provided via a media access control (MAC) or physical layer protocol (PHY) control element (CE). Prior to the SCell activation command of this example, the mobile terminal 10 may have been operating in a MIMO or CoMP reception/transmission mode with the SCell activation command indicating that the mobile terminal is to move from the MIMO or CoMP reception/transmission mode to a CA mode of operation. A transition period that is defined, for example, in terms of a predetermined number of subframes, such as eight subframes, may be provided to facilitate the transition between the different modes of operation. In this example, the RF filter(s) and antenna(s) that were previously utilized for MIMO or CoMP reception/transmission may be tuned during or following the transition period at subframe x+8 so as to support SCell operation, such as shown in FIG. 5.

The command, such as an activation or deactivation command, may be provided in this embodiment via a shared channel, such as the PDSCH. As such, the mobile terminal 10 may include means, such as the processing circuitry 22, the processor 24, the device interface 28 or the like, for causing a general acknowledgement of the information provided via the shared channel (including the command) to be sent to the access point 12. In order to ensure proper transition between the antenna port configurations, the mobile terminal may also optionally include means, such as a processing circuitry, the processor, the device interface or the like, for causing an acknowledgement of the command itself to be sent to the access point in addition to any general acknowledgement of the information provided via the shared channel. See, for example, operation 48 of FIG. 3. In the embodiment of FIG. 5, for example, the acknowledgement of the command may be provided in subframe x+4. Thus, the access point of this embodiment may continue to operate in the first mode of operation until the acknowledgement of the command is received, such as at subframe x+4, after which time both the access point and the mobile terminal may transition to the second mode of operation and may begin utilizing the other antenna port configuration at, for example, subframe x+8 in the embodiment of FIG. 5. As shown in FIG. 4, for example, the operation of the mobile terminal in accordance with the other antenna port configuration may occur at a predefined time following the receipt of the command, such as following a transition period of eight subframes, resulting, in one embodiment, in a delay of eight milliseconds.

As another example, the command that is received by the mobile terminal 10 may be a deactivation command of one carrier that triggers the mobile terminal to deactivate the secondary cell. As such, the RF filter and antenna that was previously supporting communication via the secondary cell may be reconfigured so as to support additional antenna ports for DL reception or UL transmission via other existing carriers, such as the primary cell (PCell). In an embodiment in which there are multiple carriers in a single band, the switching to more antenna ports may, in one embodiment, not occur unless all carriers in the band are deactivated. Conversely, switching to fewer antenna ports may occur in this embodiment with the activation of one carrier in the band.

In response to receiving the command to trigger switching to another antenna port configuration, the apparatus 20 embodied by the mobile terminal 10 and, in particular, means such as the processing circuitry 22, the processor 24 or the like, may be provided for determining another one of the plurality of antenna port configurations to be utilized. See operation 50 of FIG. 3. In one embodiment, the mobile terminal, such as the processor, may determine another one of a plurality of the port configurations based upon the mode of operation to which the mobile terminal is being switched. Based upon this new or second mode of operation, the mobile terminal, such as the processor, may determine the antenna port configuration that best supports or is otherwise associated with the second mode of operation. This determination may be based, for example, upon the plurality of antenna port configurations and associated information defining the modes of operation in which the various antenna port configurations are most appropriately utilized. As described above, this information regarding the various antenna port configurations may be provided by the access point 12 and stored by the mobile terminal, such as in the memory 26.

During or following the determination of the other antenna port configuration, the SRS of the antennas of the other antenna port configuration may be determined. In this regard, SRS may be utilized to estimate the UL signal to interference plus noise ratio (SINR) so as to permit efficient link adaptation and to allow for precoding of the UL transmissions. As such, the SRS may be available prior to switching to the other antenna port configuration to allow for efficient link adaptation.

In another embodiment, the access point 12 may provide an explicit command to trigger the switching to another antenna port configuration. In this embodiment, the command may be intended to explicitly direct the switching to another antenna port configuration, as opposed to providing some other form of a command, such as an activation or deactivation command, from which the antenna port reconfiguration may be inferred as described above. In one embodiment, a control element, such as a MAC or PHY control element, may be defined that provides the explicit command to trigger switching to the other antenna port configuration. In addition to simply indicating that the mobile terminal 10 should switch to another antenna port configuration, the explicit command may indicate the particular configuration of antenna port to which the mobile terminal should switch. As such, the means, such as the processing circuitry 22, the processor 24 or the like, for determining the antenna port configuration to be utilized following the transition as shown in operation 50 of FIG. 3 may be simplified with the second antenna port configuration being defined by the explicit command.

In the instance in which an explicit command is provided, a transition period may still be provided, such as shown in FIGS. 4 and 5, in order to transition from the first mode of operation to the second mode of operation serviced by the different antenna port configurations. As described above in conjunction with operation 48 of FIG. 3, an acknowledgement may be provided to the explicit command, such as within subframe x+4 in addition to any general acknowledgement of the information provided via the shared channel that includes the command that may otherwise be provided.

In yet another embodiment, the command that is provided by the access point 12 and received by the mobile terminal 10 that triggers switching to another antenna port configuration may be a command, such as an activation or deactivation command, provided, for example, by a MAC or PHY control element that triggers detection, such as blind detection, of information provided by a control channel, such as the packet data control channel (PDCCH), that, in turn, defines another antenna port configuration to which the mobile terminal should transition so as to better support a second mode of operation. In this embodiment, the command that triggers detection of information provided via the control channel may cause the mobile terminal to not only identify information provided by the control channel, but to determine the size of at least some of the information provided via the control channel with the size of the information defining the other antenna port configuration to which the mobile terminal should transition. As such, the apparatus 20 embodied by the mobile terminal of one embodiment may include means, such as the processing circuitry 22, the processor 24, the device interface 28 or the like, for determining the size of at least some of the information provided via the control channel in response to receipt of a command that triggers the detection of this information upon the control channel. See operation 46 of FIG. 3.

In one embodiment, a downlink control indicator (DCI) is provided via the control channel, such as via the PDCCH, that includes a plurality of fields, including a field of precoding information. A mobile terminal 10, such as a processor 24, of this embodiment may determine the size of the field of precoding information. The size of the information provided via the control channel, such as the size of the field of precoding information for a predefined format of DCI, may define the second antenna port configuration to which the mobile terminal should transition. In this regard, the mobile terminal, such as the memory 26, may have predefined associations between the size of the information provided by the control channel, such as the size of the field of precoding information for a predefined format of DCI, and an antenna port configuration. By way of example, the field of precoding information for DCI format 4 may be three bits in an instance in which the second antenna port configuration is to have two antennas, but may be six bits in an instance in which the second antenna port configuration is to have four antennas. Based upon the size of the information provided by the control channel, such as the size of the field of precoding information of a predefined format of DCI, the mobile terminal, such as the processor, may determine the particular antenna port configuration that is to be utilized in conjunction with the second mode of operation, such as by determining the antenna port configuration that is associated with the particular size that is determined. In the embodiment illustrated in FIG. 5, for example, the mobile terminal, such as the processor, may detect the information provided via the control channel, such as the DCI, and may determine the size of the information during the transition period, such as within the eight subframes following the issuance of the command at subframe x such that the access point 12 and the mobile terminal 10 may commence utilization of the other antenna port configuration during the second mode of operation following the transition period, such as beginning with subframe x+8.

Regardless of the manner in which the command that triggers switching to another antenna port configuration is provided, once the command has been received by the mobile terminal 10 and the other antenna port configuration that is to be utilized has been determined, the apparatus 20 embodied by the mobile terminal may include means, such as the processing circuitry 22, the processor 24, the device interface 28 or the like, for utilizing one or more antennas of the other antenna port configuration in the second mode of operation. See operation 52 of FIG. 3 as well as FIG. 4. Relative to the embodiment of FIG. 5, for example, the second mode of operation may commence at subframe x+8 such that the other antenna port configuration may also be utilized beginning at subframe x+8.

As shown in FIG. 4, the method and apparatus of one embodiment may also provide for specific signaling, such as radio resource control (RRC) signaling, to reconfigure the antenna port configuration, thereby overriding the antenna port configuration that was determined in response to the command as described above in conjunction with the embodiment of FIG. 3. In this embodiment, in an instance in which RRC signaling is provided from the access point 12 to the mobile terminal 10 that indicates that the antenna port configuration is to be changed, the mobile terminal may again change its antenna port configuration in accordance with the RRC signaling regardless of the antenna port configuration that was adopted in response to the command described above. Thus, access points and mobile terminals may continue to utilize conventional RRC signaling to configure the antenna port configuration, but may also quickly change the antenna port configuration in accordance with embodiments of the present invention in the manner described above, therefore permitting the antenna port configuration to more closely track the mode of operation and the system configuration so as to provide improved efficiency and data throughput.

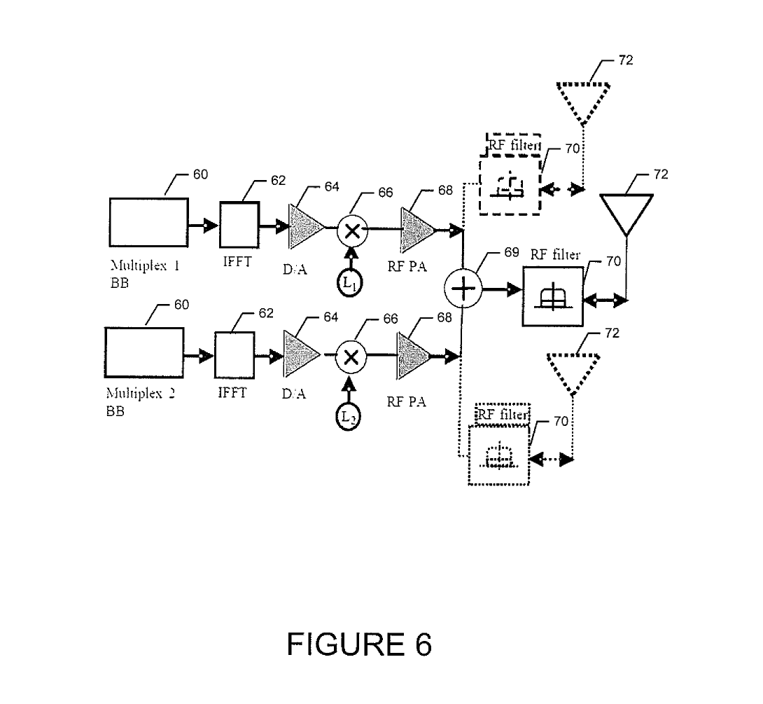

By providing for switching of the antenna port configuration based upon the mode of operation, the method and apparatus of one embodiment may switch antenna port configuration in an instance in which the mobile terminal transitions, for example, from a MIMO or CoMP mode of operation to a CA mode of operation, or vice versa. As such, the number of RF filters and antennas that are required may be moderated so as to result in somewhat less complex and simpler antenna designs. As shown in FIG. 6, for example, an RF transmitter of a mobile terminal 10 may include one or more signal processing chains that include a base band multiplexer 60, an inverse fast Fourier transformer (IFFT) 62, a digital to analog (D/A) converter 64, a combiner 66, and an RF preamplifier (PA) 68. As shown, the combiner 66 may combine an RF signal being processed via a respective signaling processing chain with control signals of a respective layer, e.g., L1, L2, etc. Each signal processing chain may be added or combined by combiner 69 and may be in communication with a plurality of RF filters 70 and associated 10 antennas 72. By controlling the antenna port configuration based upon the mode of operation, the number of RF filters and associated antennas may be controlled and potentially limited so as to simplify the design and cost of the RF transmitter, such as in comparison to an RF transmitter that would be required to support a MIMO or CoMP mode of operation concurrent with an inter-band CA mode of operation. Indeed, some of the RF filters and antennas of the embodiment of FIG. 6 are shown in dashed lines to indicate that the respective RF filters and antennas may be switchably included or excluded depending upon the particular antenna port configuration that is selected based upon the intended mode of operation.

Although an RF transmitter is shown in FIG. 6, a similar RF receiver design may be enabled in accordance with embodiments of the present invention in which the number of RF filters and antennas is modified based upon the mode of operation. For example, a mobile terminal 10 may be capable of 4 layer UL MIMO for all bands and may be capable of 2 layer UL MIMO for inter-band combinations. In an instance in which the mobile terminal of this embodiment is configured to aggregate carriers from band i and from band j, and carriers from both bands are activated, the mobile terminal may support 2 layer UL MIMO in each carrier. However, in an instance in which the carriers in band j are deactivated, the mobile terminal of one embodiment may borrow one or more RF filter(s) and antenna(s) from band j to support 4 layer MIMO in band i in accordance with example embodiments of the present invention.

The LTE specification defines different numbers of precoding matrices to be available for 2 antenna port and 4 antenna port configurations in the UL. In this regard, in a 2 Tx configuration with v representing the number of MIMO layers, there are 6 precoding matricdes for v=1 and 1 precoding matrix for v=2 with no precoding matrices being available for v>2.

Additionally, in a 4 Tx configuration, there are 24 precoding matrices for v=1, 16 precoding matrices for v=2, 12 precoding matrices for v=3 and 1 precoding matrix for v=4. By switching to 4 Tx from 2 antenna ports, more flexibility in rank adaptation and for precoding matrix selection may be advantageously provided.

Although described above, both in general terms and from the perspective of a mobile terminal 10, reference is now made to FIG. 7 in which the method and apparatus of an example embodiment of the present invention are described from the perspective of an access point 12. As shown in operation 80 of FIG. 7, the apparatus 20 embodied by an access point may include means, such as the processing circuitry 22, the processor 24, the device interface 28 or the like, for causing a plurality of antenna port configurations to be provided to the mobile terminal for one or more of an UL mode of operation, a DL mode of operation or both UL and DL modes of operation. As described above, the plurality of antenna port configurations may be associated with various channels and/or modes of operation and the access point may also retain a record, such as in memory 26, of these associations. The apparatus as embodied by the access point may also include means, such as the processing circuitry, the processor, the device interface or the like, for providing for communications with the mobile terminal in the first mode of operation via one or more antennas in a first antenna port configuration. See operation 82 of FIG. 7.

The apparatus 20 as embodied by this embodiment of the access point 12 may also include means, such as the processing circuitry 22, the processor 24, the device interface 28 or the like, for causing a command to be sent to the mobile terminal 10 to trigger switching to another antenna port configuration. See operation 84 of FIG. 7. As described above, this command may be an implicit command, an explicit command or may be a command triggering the mobile terminal to evaluate information, such as grant scheduling, provided via a control channel. Indeed, in this latter embodiment, the apparatus embodied as the access point may also include means, such as the processing circuitry, the processor, the device interface or the like, for causing information to be sent to the mobile terminal via the control channel, such as a DCI provided via the PDCCH, with the size of at least some of the information being determinative of another antenna port configuration to which the mobile terminal should switch, such as following a transition period as described above and as shown in FIGS. 4 and 5. See operation 86 of FIG. 7.

The apparatus 20 embodied by the access point 12 may also optionally include means, such as the processing circuitry 22, the processor 24, the device interface 28 or the like, for receiving a general acknowledgement of information provided via a shared channel that includes the command and also for receiving an acknowledgement of the command in addition to the general acknowledgement. See operations 88 and 90 of FIG. 7. As such, the reliability of the switching between antenna port configurations may be improved by utilizing the acknowledgement of the command, such as at subframe x+4 in the embodiment of FIG. 4, which serves to avoid ambiguity in the antenna port configurations and the timing of such a transition. The apparatus embodied by the access point may also include means, such as the processing circuitry, the processor, the device interface or the like, for providing for communication with the mobile terminal in the second mode of operation via one or more antennas having the other antenna port configuration, such as following the transition, e.g., beginning at subframe x+8 in the embodiment of FIG. 5. See operation 92 of FIG. 7.

A method and apparatus are therefore provided according to an example embodiment in order to provide for improved switching between antenna port configurations as the mode of operation of a mobile terminal 10 changes. In this regard, the method and apparatus of one embodiment may facilitate switching between antenna port configurations so that the mobile terminal may have capabilities that are tailored to the current mode of operation, such as by supporting different combinations of the MIMO, CoMP and/or CA capabilities. By providing for switching between antenna port configurations in an efficient and timely manner, the antenna port configuration of a mobile terminal may more closely track the channel characteristics such that the resulting system performance may be improved.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method comprising:
utilizing one or more antennas in a first antenna port configuration in a first mode of operation;
receiving a command that triggers switching to another antenna port configuration;
determining another one of a plurality of antenna port configurations to be utilized in response to the command; and
utilizing one or more antennas of the another one of the antenna port configurations in a second mode of operation.

2-12. (canceled)

13. An apparatus comprising:
at least one processor; and
at least one memory including computer program code,
the at least one memory and the computer program code configured to, with the at least one processor, cause the apparatus at least to:
utilize one or more antennas in a first antenna port configuration in a first mode of operation;
receive a command that triggers switching to another antenna port configuration;
determine another one of a plurality of antenna port configurations to be utilized in response to the command; and
utilize one or more antennas of the another one of the antenna port configurations in a second mode of operation.

14. The apparatus according to claim 13 wherein one of the first and second modes of operation is a multiple input multiple output (MIMO) or coordinated multipoint transmission (CoMP) mode of operation and another one of the first and second modes of operation is a carrier aggregation (CA) mode of operation.

15. The apparatus according to claim 13 wherein the at least one memory and the computer program code are further configured to, with the at least one processor, cause the apparatus to cause the plurality of antenna port configurations to be stored for one or more of an uplink mode of operation, a downlink mode of operation or both uplink and downlink modes of operation.

16. (canceled)

17. The apparatus according to claim 13 wherein the at least one memory and the computer program code are configured to, with the at least one processor, cause the apparatus to receive the command by receiving an activation command for a carrier band that is indicative of a transition from the first mode of operation to the second mode of operation.

18. The apparatus according to claim 13 wherein the at least one memory and the computer program code are configured to, with the at least one processor, cause the apparatus to receive the command by receiving a deactivation command for a carrier band that is indicative of a transition from the first mode of operation to the second mode of operation.

19. The apparatus according to claim 13 wherein the at least one memory and the computer program code are further configured to, with the at least one processor, cause the apparatus to determine a size of at least some information provided via a control channel in response to receiving the command, wherein the at least one memory and the computer program code are configured to, with the at least one processor, cause the apparatus to determine the another one of the antenna port configurations to be utilized by determining the another one of the antenna port configurations to be utilized based upon the size of at least some of the information provided via the control channel.

20. The apparatus according to claim 19 wherein the at least one memory and the computer program code are configured to, with the at least one processor, cause the apparatus to determine the size of at least some of the information provided via the control channel by determining the size of at least one field of a downlink control indicator (DCI).

21. The apparatus according to claim 13, wherein the at least one memory and the computer program code are further configured to, with the at least one processor, cause the apparatus to cause an acknowledgement of the command to be sent to an access point.

22. The apparatus according to claim 21 wherein the at least one memory and the computer program code are configured to, with the at least one processor, cause the apparatus to cause the acknowledgement of the command to be sent by causing the acknowledgement of the command to be sent in addition to a general acknowledgement of information provided via a shared channel that includes the command.

23. (canceled)

24. The apparatus according to claim 13 wherein the apparatus comprises a mobile terminal.

25-38. (canceled)

39. An apparatus comprising:
at least one processor; and
at least one memory including computer program code,
the at least one memory and the computer program code configured to, with the at least one processor, cause the apparatus at least to:
provide for communications with a mobile terminal in a first mode of operation via one or more antennas in a first antenna port configuration;
cause a command to be sent to the mobile terminal that triggers switching to another antenna port configuration as selected from a plurality of predefined antenna port configurations; and
provide for communications with the mobile terminal in a second mode of operation via one or more antennas of the another one of the antenna port configurations.

40. The apparatus according to claim 39 wherein one of the first and second modes of operation is a multiple input multiple output (MIMO) or coordinated multipoint transmission (CoMP) mode of operation and another one of the first and second modes of operation is a carrier aggregation (CA) mode of operation.

41. (canceled)

42. The apparatus according to claim 41 wherein different antenna port configurations are defined for different channels.

43-44. (canceled)

45. The apparatus according to claim 39 wherein the at least one memory and the computer program code are further configured to, with the at least one processor, cause the apparatus to cause information to be sent to the mobile terminal via a control channel with a size of at least some of the information being determinative of the another one of the antenna port configurations to be utilized for subsequent communications.

46. The apparatus according to claim 45 wherein the at least one memory and the computer program code are configured to, with the at least one processor, cause the apparatus to cause information to be sent to the mobile terminal by causing a downlink control indicator (DCI) to be sent to the mobile terminal via the control channel with a size of at least one field of the DCI being determinative of the another one of the antenna port configurations to be utilized for subsequent communications.

47. An apparatus according to any claim 39 wherein the at least one memory and the computer program code are further configured to, with the at least one processor, cause the apparatus to receive an acknowledgement of the command from the mobile terminal.

48. The apparatus according to claim 47 wherein the at least one memory and the computer program code are further configured to, with the at least one processor, cause the apparatus to receive a general acknowledgement of information provided via a shared channel that includes the command in addition to receiving the acknowledgement of the command from the mobile terminal.

49. The apparatus according to claim 39, wherein the at least one memory and the computer program code are configured to, with the at least one processor, cause the apparatus to cause the command to be sent to the mobile terminal by causing a control element to be sent to the mobile terminal that explicitly defines the antenna port configuration to be utilized in the second mode of operation.

50. The apparatus according to claim 39, wherein the apparatus comprises an access point.

51-52. (canceled)
